(19) United States
(12) Patent Application Publication
(10) Pub. No.: US 2009/0097960 A1
(43) Pub. Date: Apr. 16, 2009

(54) Vertical axis windmill assembly

(76) Inventor: Rande Williams, Merrick, NY (US)

Correspondence Address: DILWORTH & BARRESE, LLP, 333 EARLE OVINGTON BLVD., SUITE 702, UNIONDALE, NY, 11553, US

(21) Appl. No.: 11/974,769

(22) Filed: Oct. 16, 2007

(51) Int. Cl. F03D 3/06; F04D 29/36

(52) U.S. Cl. 415/4.2; 290/44; 416/132 B; 416/196 A

(57) ABSTRACT

A windmill assembly includes (a) a support frame; (b) a rotor rotatably mounted to the support frame for rotation around a vertical axis in response to the movement of wind passing the wind engine. The rotor includes (i) a shaft, (ii) at least two wings extending radially from the shaft, and (iii) a plurality of vanes pivotally mounted to one side of each wing and movable between a closed first position wherein the vanes prevent wind from passing through the wing and an open second position wherein the vanes permit wind to pass through spaces between the vanes and through the wing, wherein the wings are arranged such that when the vanes on one wing are in the closed position the vanes on the other wing are at least partially open.

### BACKGROUND

1. Field of the Invention

The present invention relates to wind turbines and the like, and more particularly to a vertical axis windmill which uses the kinetic energy of moving air to provide rotational energy for generating electrical energy and other useful purposes.

2. Background of the Art

Windmills are long known in the art for converting wind energy into useful mechanical energy. The mechanical energy can be subsequently converted to electrical energy by a generator. Windmills typically have either a horizontal axis or a vertical axis of rotation. Vertical axis windmills have the advantage of being omnidirectional, i.e., they do not require alignment of the rotor with the wind stream. Moreover, the drive train can be close to the ground rather than being high above the ground at the rotor level.

U.S. Pat. No. 6,688,842 to Boatner discloses a vertical axis wind engine which includes a support structure, a rotor mounted rotatably on the support structure for rotation about a vertical axis, and at least one airfoil for causing the rotor to rotate about the vertical axis in response to wind passing the wind engine. The airfoil has vertically extending leading and trailing edges, an angle-of-attack axis extending horizontally through the leading and trailing edges, and a pivotal axis extending vertically intermediate the leading and trailing edges. The airfoil is mounted on the rotor for pivotal movement about the pivotal axis and the rotor includes components for limiting pivotal movement of the airfoil to first and second limits of pivotal movement. The airfoil is free to pivot about the pivotal axis intermediate the first and second limits of pivotal movement as the rotor rotates about the vertical axis in order to thereby enable the airfoil to align the angle-of-attack axis according to the wind.

Other vertical axis windmills are disclosed in U.S. Pat. Nos. 4,031,405, 4,218,183, 4,474,529, 4,725,194 and 5,057,696, for example.

What is needed, however, is an omnidirectional windmill which is inexpensive to fabricate, easily constructed and sufficiently portable to be carried by a vehicle to various locations while fully assembled.

### SUMMARY

Provided herein is a windmill assembly comprising (a) a support frame; (b) a rotor rotatably mounted to the support frame for rotation around a vertical axis in response to the movement of wind passing the wind engine. The rotor includes (i) a shaft, (ii) at least two wings extending radially from the shaft, and (iii) a plurality of vanes pivotally mounted to one side of each wing and movable between a closed first position wherein the vanes prevent wind from passing through the wing and an open second position wherein the vanes permit wind to pass through spaces between the vanes and through the wing, wherein the wings are arranged such that when the vanes on one wing are in the closed position the vanes on the other wing are at least partially open.

### BRIEF DESCRIPTION OF THE DRAWINGS

Various embodiments are described below with reference to the drawings wherein:

FIG. 1 is a perspective view of the invention;

FIG. 2 is an elevational view of the invention;

FIG. 3 is a plan view of the rotor assembly;

FIG. 4 is a detailed view of the vane linkage to the vertical supports of the wing; and,

FIG. 5 is a perspective view illustrating a vane having a strip of dampening material.

### DETAILED DESCRIPTION OF PREFERRED EMBODIMENT(S)

The present invention is easily constructed from inexpensive materials and can be carried by a vehicle to various locations either in the assembled condition or as a kit of components for assembly on location with simple tools. It is useful, for example, in rural areas where one or more of the windmills of the invention can be situated in fields to capture and convert wind energy for the generation of electricity. Alternatively, the windmill can be placed on the roof of a building to provide a supplementary source of electrical power.

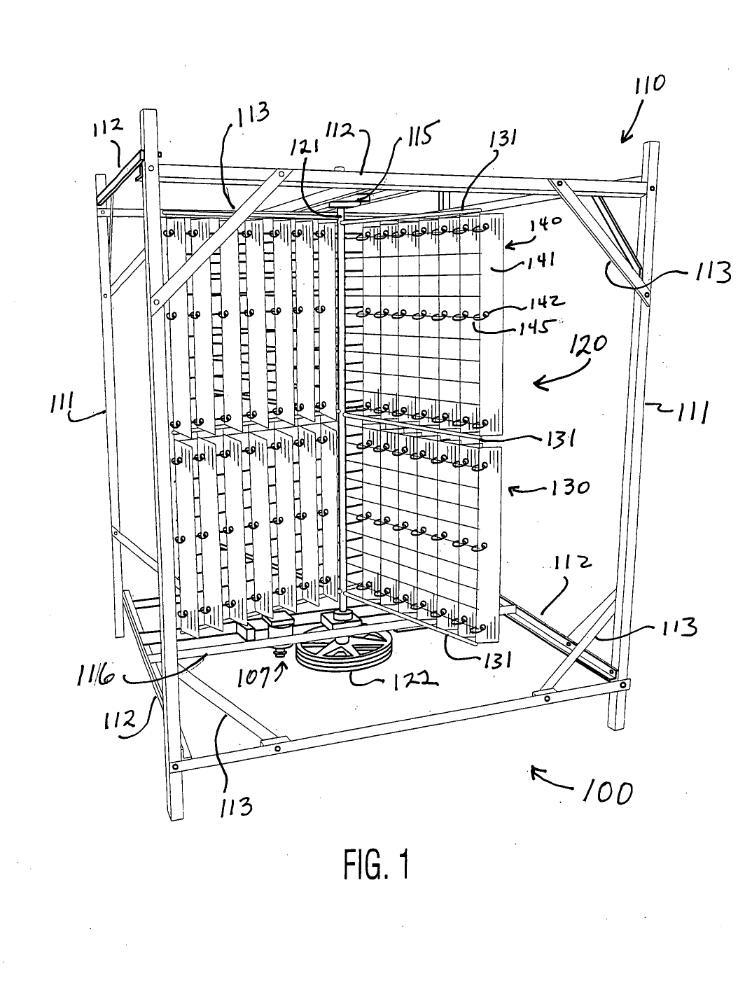

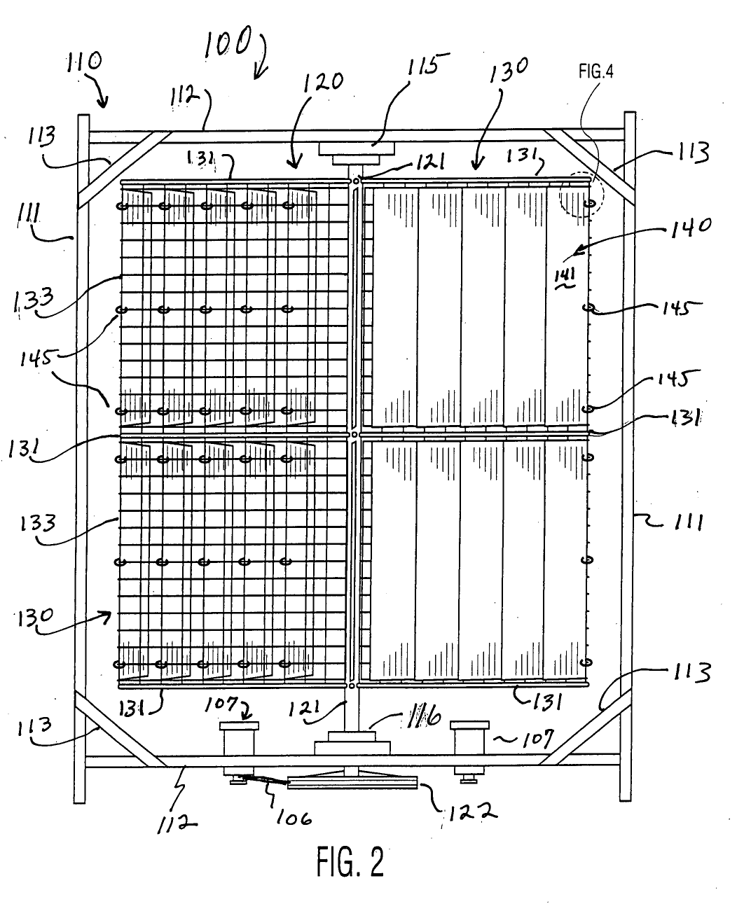

Referring now to FIGS. 1 and 2, the windmill assembly 100 of the invention includes a rotor assembly 120, rotatably mounted within a frame 110. Preferably, the rotor assembly 120 is operatively connected to one or more electrical generators 107.

More particularly, frame 110 includes a vertical bars 111 and horizontal bars 112 connected to form a box-like structure for supporting the rotor assembly therein. Diagonal braces 113, also connecting the horizontal bars 112 to the vertical bars 111, provide additional mechanical support at the corners of the frame 110. Top rotor support 115 and bottom rotor support 116 extend horizontally at the top and bottom, respectively, of frame 110 to support the rotor assembly 120, which is vertically mounted therebetween so as to be able to freely rotate in clockwise or counterclockwise directions.

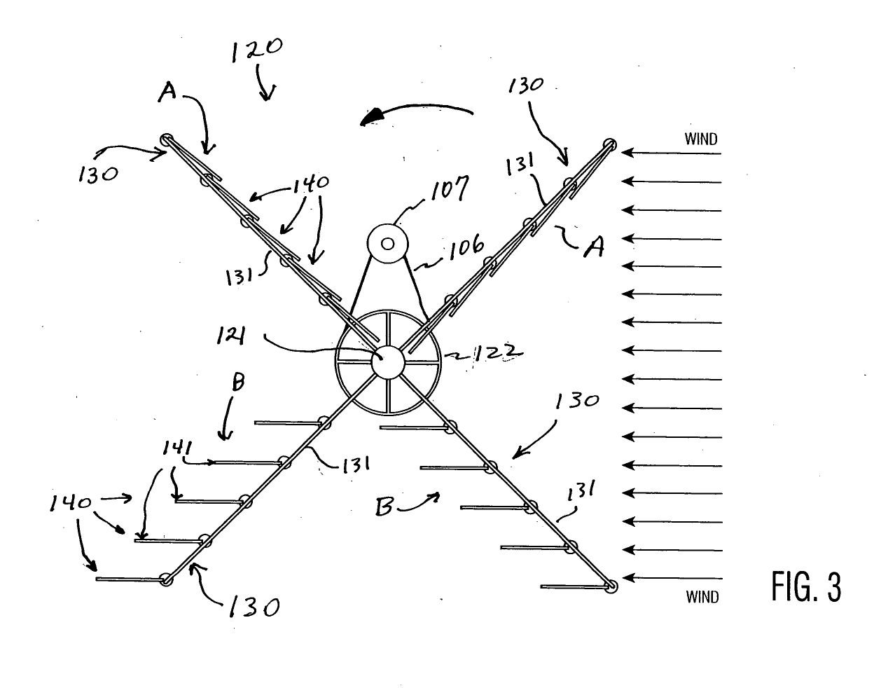

The frame is preferably fabricated in whole or in part from metal such as aluminum or steel. The vertical and horizontal bars (111, 112) and diagonal braces 113 can be fastened together by any suitable means such as screw attachments or other means to allow on-site assembly of the windmill. Referring also now to FIGS. 2 and 3, the rotor assembly 120 includes a vertical shaft 121 rotably mounted between the top and bottom rotor supports (115, 116). At the bottom of shaft 121 a wheel 122 is operatively connected to generator 107 by means of belt 106. Alternatively a gearing mechanism can be used to convey rotational movement of the shaft 121 to the generator 107.

Referring now also to FIG. 3, the rotor assembly includes at least two, and preferably three or four, wings 130.

The wings 130 each include horizontal supports 131 for supporting a mesh structure 133. The mesh 133 preferably is a wire mesh such as typically used for fencing. Preferably, the wire mesh is a metal wire mesh which is coated with a corrosion resistant material. In a preferred embodiment, mesh 133 includes metal horizontal and vertical rods (134 and 135, respectively) coated with polyvinylchloride (PVC). A mesh suitable for use in the invention is commercially available from HY-TEN Company under the designation Masterplax. Alternatively, the mesh 133 can be fabricated from rods of engineering plastic such as polycarbonate, acrylates, polyvinylchloride and the like.

Wings 130 include a plurality of vertically oriented vanes 140 pivotally mounted to the mesh 133. Vanes 140 comprise blades 141 preferably fabricated from plastic, wood, or metal strips. The vanes can generally range in width from about 24 inches to about 48 inches, although widths outside of this range can be used where appropriate. Most preferably, blades 141 are fabricated from corrugated plastic sheets, cellular PVC board, or any rigid, durable board material. Corrugated plastic sheet material suitable for use in making blades 141 of the invention is commercially available from Coroplast Co. of Dallas, Tex. Corrugated plastic sheets offer the advantages of being durable, lightweight and inexpensive. Cellular PVC board material suitable for use in the invention is commercially available under the designation Sintra® from Alcan Composites.

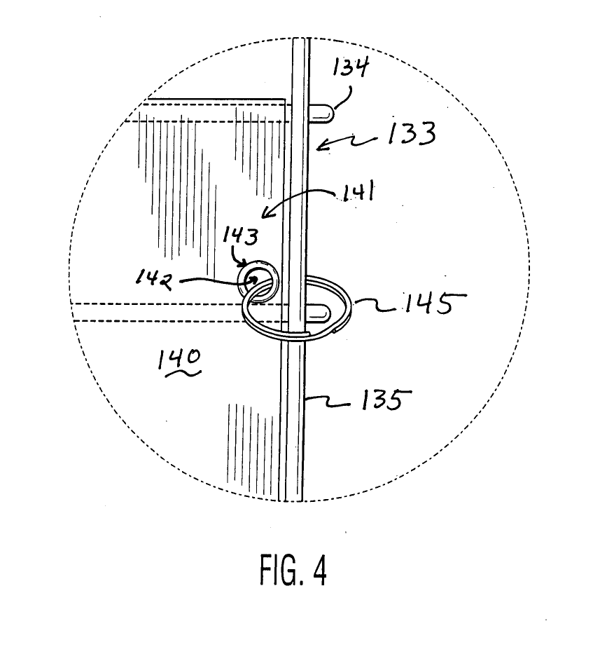

Referring also now to FIG. 4, the blades 141 include apertures 142 preferably reinforced by annular grommets 145. Ring members 145 pivotally attach the blades 141 to the mesh 133 by extending through respective apertures 142 and around a vertical rod 135 of the mesh 133. The ring members 145 can be of the type typically used to mount keys to a key chain or key holder. Such key rings are may be opened manually to allow a vertical rod 135 and an edge portion of the blade 141 to be engaged within the ring.

Referring again to FIG. 3, the vanes 140 are pivotally movable between a closed first position A wherein they lie relatively flat against the mesh 133 of the wing 130 so as to block the passage of air therethrough, and an open second position B wherein the vanes 140 extend outward from the mesh 133 to permit air to pass through. As can be seen from FIG. 3, the wind presses against the wings with closed vanes but exerts little force against the wings with open vanes. Accordingly, no matter which direction the wind blows, rotor 120 will be moved by the wind and, in the windmill assembly 100 as shown, will always rotate in counterclockwise direction C. If the vanes 140 are mounted on the opposite side of the wings 130, the rotor 120 will rotate in the other direction.

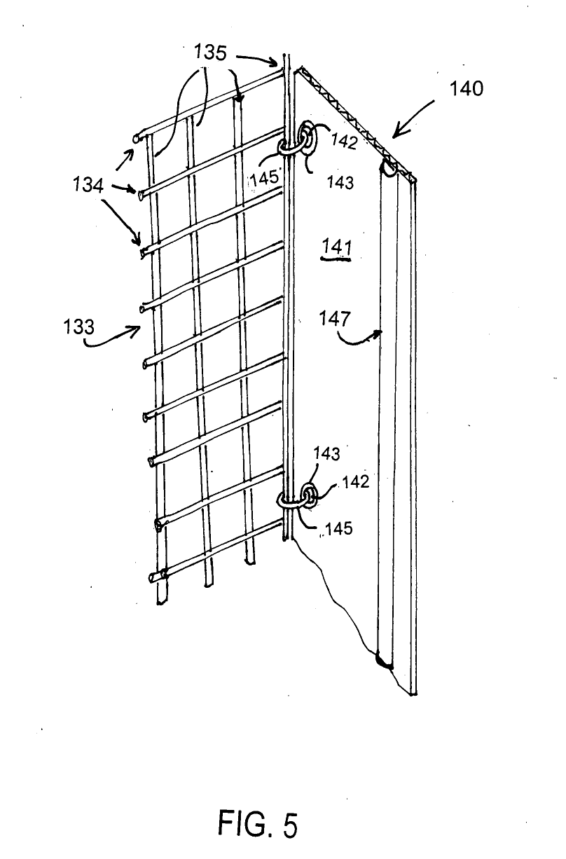

Referring now to FIG. 5, the wings can optionally include one or more dampers for reducing noise. For example, a damper strip 147 of soft rubber, felt, or other sound and/or vibration damping material can be attached to the blade 141 in the vicinity of the edge opposite to that which is pivotally mounted to the wing on the side of the blade which makes swinging contact with the mesh 133 or adjacent blade. The damper 147 reduces noise, thereby facilitating the placement of the windmill in more populated locations such as on rooftops.

Advantageous feature of the invention are that the parts and materials are inexpensive, commonly available and easily replaceable. The individual components can be transported disassembled as a kit and easily assembled on-site with a few very simple tools without the need for skilled labor. The windmill can be constructed of any suitable size. It is easily carried to, for example, rural locations where there is an abundant supply of wind to generate electrical energy. The windmill assembly 100 is easily and inexpensively repaired and parts easily replaced.

While the above description contains many specifics, these specifics should not be construed as limitations of the invention, but merely as exemplifications of preferred embodiments thereof. Those skilled in the art will envision many other embodiments within the scope and spirit of the invention as defined by the claims appended hereto.

What is claimed is:

1. A windmill assembly comprising:
a) a support frame;
b) a rotor assembly rotatably mounted to the support frame for rotation around a vertical axis in response to the movement of wind passing the wind engine, wherein the rotor assembly includes
i) a shaft
ii) at least two wings extending radially from the shaft
iii) a plurality of vanes pivotally mounted to one side of each wing and movable between a closed first position wherein the vanes prevent wind from passing through the wing and an open second position wherein the vanes permit wind to pass through spaces between the vanes and through the wing,
wherein the wings are arranged such that when the vanes on one wing are in the closed position the vanes on the other wing are at least partially open.

2. The windmill assembly of claim 1 wherein the support frame includes horizontal and vertical bars connected to form a box-like structure for holding the rotor assembly therein.

3. The windmill assembly of claim 1 wherein the wings each include a wire mesh material supported on radially extending horizontal supports, the wire mesh having openings to permit the passage therethrough of wind.

4. The windmill assembly of claim 3 wherein the wire mesh material comprises horizontal and vertical rods coated with a corrosion protective coating.

5. The windmill assembly of claim 4 wherein the protective coating comprises polyvinylchloride.

6. The windmill assembly of claim 1 wherein the vanes each comprise elongated panels vertically oriented and hingedly connected on a first vertical edge to the wing.

7. The windmill assembly of claim 6 wherein the panels are fabricated from a rigid, durable board material.

8. The windmill assembly of claim 7 wherein the board material is corrugated plastic or cellular PVC.

9. The windmill assembly of claim 6 wherein the panels each have at least one aperture in the vicinity of the first vertical edge.

10. The windmill assembly of claim 9 wherein the aperture is bordered by an annular grommet.

11. The windmill assembly of claim 6 wherein each panel includes a freely swinging second vertical edge opposite to the first vertical edge, and wherein each panel includes a strip of dampening material attached thereto in the vicinity of the second vertical edge on a side of the panel which is adjacent to the wing when the vane is in the closed position.

12. The windmill assembly of claim 11 wherein the dampening material comprises soft rubber or felt.

13. The windmill assembly of claim 1, wherein the rotor assembly further includes means for dampening sound and/or vibration.

14. The windmill assembly of claim 13 wherein the means for dampening sound and/or vibration comprises a soft rubber or felt material positioned so as to reduce sound and/or vibration caused by the movement of the vanes to the closed first position.

15. The windmill assembly of claim 9 wherein each panel has at least one aperture and is hingedly connected to the wing by means of a ring disposed through the aperture and around a vertical rod in the wing.

16. The windmill assembly of claim 1 further comprising an electrical generator and means for operatively connecting the shaft to the generator so as to transfer rotational motion thereto.

17. The windmill assembly of claim 16 wherein the means for operatively connecting the shaft to the generator comprises a belt attachment between the generator and a wheel fixed to the shaft or a gear connecting the shaft to the generator.

18. The windmill assembly of claim 1 comprising four wings.

19. A windmill assembly kit comprising:
a) a plurality of bars which are connectable with each other to form a support frame;
b) a rotor assembly which is mountable within the support frame, the rotor assembly including
i. a shaft which is rotatably mounted within the frame in a vertical orientation,
ii. support bars which are connectable to the shaft so as to extend radially therefrom,
iii. wire mesh material connectable to the support bars of the rotator assembly,
iv. a plurality of vanes hingedly connectable to the wire mesh material, and
v. ring elements for connecting the vanes to the wire mesh.

20. The kit of claim 19 wherein the vanes comprise panels fabricated from corrugated plastic or cellular PVC board.
